(19) United States
(12) Patent Application Publication
(10) Pub. No.: US 2022/0277217 A1
(43) Pub. Date: Sep. 1, 2022

(54) SYSTEM AND METHOD FOR MULTIMODAL NEURO-SYMBOLIC SCENE UNDERSTANDING

(71) Applicant: Robert Bosch GmbH, Stuttgart (DE)

(72) Inventors: Jonathan FRANCIS, Pittsburgh, PA (US); Alessandro OLTRAMARI, Pittsburgh, PA (US); Charles SHELTON, Monroeville, PA (US); Sirajum MUNIR, Pittsburgh, PA (US)

(21) Appl. No.: 17/186,640

(22) Filed: Feb. 26, 2021

(51) Int. Cl. G06N 20/00; G06F 16/587; G06K 9/62; G06F 16/583; G06K 9/00

(52) U.S. Cl. CPC G06N 20/00; G06F 16/587; G06K 9/6289; G06F 16/583; G06K 9/00791

(57) ABSTRACT

A system for image processing includes a first sensor configured to capture at least one or more images, a second sensor configured to capture sound information, a processor in communication with the first sensor and second sensor, wherein the processor is programmed to receive the one or more images and sound information, extract one or more data features associated with the images and sound information utilizing an encoder, output metadata via a decoder to a spatiotemporal reasoning engine, wherein the metadata is derived utilizing the decoder and the one or more data features, determine one or more scenes utilizing the spatiotemporal reasoning engine and the metadata, and output a control command in response to the one or more scenes.

### TECHNICAL FIELD

The present disclosure relates to image processing utilizing sensors such as cameras, radar, microphones, etc.

### BACKGROUND

Systems may be capable of performing scene understanding. Scene understanding may refer to a system's ability to reason about objects and the events they engage in, on the basis of their semantic relationship with other objects in the environment and/or the geospatial or temporal structure of the environment, itself. A fundamental goal for the task of scene understanding is to generate a statistical model that can predict (e.g., classify) high-level semantic events, given some observation of the context in a scene. Observation of a scene context may be enabled through the use of sensor devices placed at various locations that allow the sensors to obtain contextual information from the scene in the form of sensor modalities, such as video recordings, acoustic patterns, environmental temperature time-series information, etc. Given such information from one or more modalities (e.g., sensors), the system may classify events that are initiated by entities in the scene.

### SUMMARY

According to one embodiment, a system for image processing includes a first sensor configured to capture at least one or more images, a second sensor configured to capture sound information, a processor in communication with the first sensor and second sensor, wherein the processor is programmed to receive the one or more images and sound information, extract one or more data features associated with the images and sound information utilizing an encoder, output metadata via a decoder to a spatiotemporal reasoning engine, wherein the metadata is derived utilizing the decoder and the one or more data features, determine one or more scenes utilizing the spatiotemporal reasoning engine and the metadata, and output a control command in response to the one or more scenes.

According to a second embodiment, a system for image processing, including a first sensor configured to capture a first set of information indicative of an environment, a second sensor configured to capture a second set of information indicative of the environment, a processor in communication with the first sensor and second sensor. The processor is programmed to receive the first and second set of information indicative of the environment, extract one or more data features associated with the images and sound information utilizing an encoder, output metadata via a decoder to a spatiotemporal reasoning engine, wherein the metadata is derived utilizing the decoder and the one or more data features, determine one or more scenes utilizing the spatiotemporal reasoning engine and the metadata, and output a control command in response to the one or more scenes.

According to a third embodiment, a system for image processing includes a first sensor configured to capture a first set of information indicative of an environment, a second sensor configured to capture a second set of information indicative of the environment, and a processor in communication with the first sensor and second sensor. The processor is programmed to receive the first set and second set of information indicative of the environment, extract one or more data features associated with the first set and second set of information indicative of the environment, output metadata indicating one or more data features, determine one or more scenes utilizing the metadata, and output a control command in response to the one or more scenes.

### BRIEF DESCRIPTION OF THE DRAWINGS

FIG. 1 shows a schematic view of a monitoring setup.

FIG. 2 is an overview system diagram of a wireless system according to an embodiment of the disclosure.

FIG. 3A is a first embodiment of a computing pipeline.

FIG. 3B is an alternative embodiment of a computing pipeline that utilizes fusing of sensor data.

FIG. 4 is an illustration of an example scene captured from the one or more video cameras and sensors.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

According to an embodiment, an embodiment includes a framework for multimodal neuro-symbolic scene understanding. The framework may also be referred to as a system. The framework may include a confluence of hardware and software. From the hardware side, data from various sensor device (“modalities”) are streamed to the software components, via a wireless protocol. From there, initial software processes combine and transform these sensor modalities, in order to provide predictive context for further downstream software processes, such as machine learning models, artificial intelligence frameworks, and web applications for user localization and visualization. Together, these components of the System enable scene understanding, an environmental event-detection and reasoning paradigm, where sub-events are detected and classified at a low-level, more abstract events are reasoned about at a high-level, and information at both levels are made available to the operator or end-users, despite the possibility of the events spanning arbitrary time periods. Because these software processes fuse multiple sensor modalities together, may include neural networks (NNs) as the event-predictive models, and may include symbolic knowledge representation & reasoning (KRR) frameworks as the temporal reasoning engines (e.g., a spatiotemporal reasoning engine), the System can be said to perform multimodal neuro-symbolic reasoning for scene understanding.

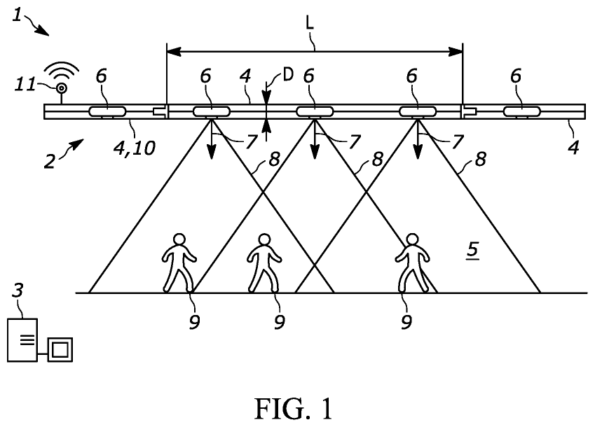

FIG. 1 shows a schematic view of a monitoring installation or setup 1. The monitoring installation 1 comprises a monitoring module arrangement 2 and an evaluation device 3. The monitoring module arrangement 2 comprises a plurality of monitoring modules 4. The monitoring module arrangement 2 is arranged on a ceiling of the monitoring area 5. The monitoring module arrangement 2 is configured for the visual, image-based and/or video-based monitoring of the monitoring area 5.

The monitoring modules 4 in each case includes a plurality of cameras 6. In particular, the monitoring module 4 may include at least three cameras 6 in one embodiment. The cameras 6 may be configured as color cameras and, especially, as compact cameras, for example Smartphone cameras. The cameras 6 may have a direction of view 7, an angle of view and a field of view 8. The cameras 6 of a monitoring module 4 are arranged with a similarly aligned direction of view 7. In particular, the cameras 6 are arranged so that the cameras 6 in each case have an overlap of the field of view 8 on a pair-by-pair basis. The monitoring cameras 6 can be arranged at fixed positions and/or at fixed camera intervals from one another in the monitoring module 4.

The monitoring modules 4 can be coupled to one another mechanically and via a data communication connection in one embodiment. In another embodiment, wireless connections may also be utilized. In one embodiment, the monitoring module arrangement 2 can be obtained through the coupling of the monitoring modules 4. One monitoring module 4 of the monitoring module arrangement 2 is configured as a collective transmit module 10. The collective transmit module 10 has a data interface 11. The data interface may, in particular, form the communication interface. The monitoring data of all monitoring modules 4 are supplied to the data interface 11. Monitoring data comprise the image data recorded by the cameras 6. The data interface 11 is configured to supply all image data collectively to the evaluation device 3. To do this, the data interface 11 can be coupled, in particular via a data communication connection, to the evaluation unit 3. The monitoring module may communicate via wireless data connection (e.g., Wi-Fi, LTE, cellular, etc.).

A moving object 9 can be detected and/or tracked in the monitoring area 5 by utilization of the monitoring installation 1. To do this, the monitoring module 4 supplies monitoring data to the evaluation device 3. The monitoring data may include camera data and other data acquired from various sensors monitoring the environment. Such sensors may include hardware sensor devices include any or a combination of ecological sensors (temperature, pressure, humidity, etc.), visual sensors (surveillance cameras), depth sensors, thermal imagers, localization metadata (geospatial timeseries), receivers of wireless signals (WiFi, Bluetooth, Ultra-wideband, etc.) and acoustic sensors (vibration, audio), or any other sensor configured to collect information. The camera data have may have images of the monitoring of the monitoring area 5 by utilization of the cameras 6. The evaluation device 3 can, for example, evaluate and/or monitor the monitoring area 5 stereoscopically.

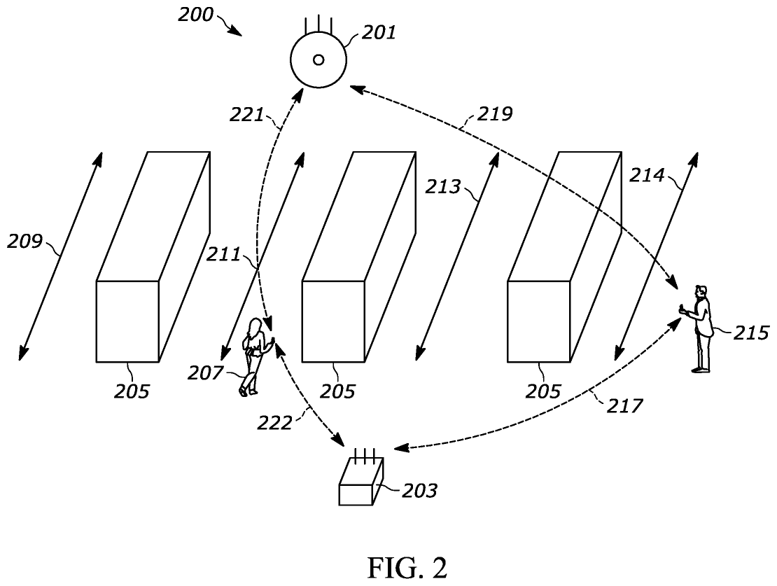

FIG. 2 is an overview system diagram of a wireless system 200 according to an embodiment of the disclosure. In one embodiment, the wireless system 200 may include a wireless unit 201 that utilized to generate and communicate channel state information (CSI) data or any wireless signals and data. The wireless unit 201 may communicate with mobile devices (e.g. cell phone, wearable device, tablet) of an employee 215 or a customer 207 in a monitoring situation. For example, a mobile device of an employee 215 may send wireless signal 219 to the wireless unit 201. Upon reception of a wireless packet, system unit 201 obtains the associated CSI values of packet reception, or any other data. Also, the wireless packet may contain identifiable information about the device ID, e.g., MAC address that is used to identify employee 215. Thus, the system 200 and wireless unit 201 may not utilize the data exchanged from the device of the employee 215 to determine various hot spots.

While WiFi may be utilized as a wireless communication technology, any other type of wireless technology may be utilized. For example, Bluetooth may be utilized if the system can obtain CSI from a wireless chipset. The system unit may be able to contain a WiFi chipset that is attached to up to three antennas, as shown by wireless unit 201 and wireless unit 203. The wireless unit 201 may include a camera to monitor various people walking around a POI. In another example, the wireless unit 203 may not include a camera and simply communicate with the mobile devices.

The system 200 may cover various aisles (among other environments), such as 209, 211, 213, 214. The aisles may be defined as a walking path between shelving 205 or walls of a store front. The data collected between the various aisles 209, 211, 213, 214 may be utilized to generate a heat map and focus on traffic of a store. The system may analyze the data from all aisles and utilize that data to identify traffic of other areas of the store. For example, data collected from the mobile device of various customers 207 may identify areas that the store receive high traffic. That data can be used to place certain products. By utilizing the data, a store manager can determine where the high-traffic real estate is located versus low-traffic real estate.

The CSI data may be communicated in packets found in wireless signals. In one example, a wireless signal 221 may be generated by a customer 207 and their associated mobile device. The system 200 may utilize the various information found in the wireless signal 221 to determine whether the customer 207 is an employee or other characteristic. The customer 207 may also communicate with wireless unit 203 via signal 222. Furthermore, the packet data found in the wireless signal 221 may communicate with both wireless unit 201 or unit 203. The packet data in the wireless signal 221, 219, and 217 may be utilized to provide information related to motion prediction and traffic data related to mobile devices of employees, customers, etc.

While the wireless transceiver 201 may communicate CSI data, other sensors, devices, sensor streams and software may be utilized. These hardware sensor devices include any or a combination of ecological sensors (temperature, pressure, humidity, etc.), visual sensors (surveillance cameras), depth sensors, thermal imagers, localization metadata (geospatial timeseries), receivers of wireless signals (WiFi, Bluetooth, Ultra-wideband, etc.) and acoustic sensors (vibration, audio), or any other sensor configured to collect information.

The various embodiment described may be predicated on a distributed messaging and applications platform, which facilitates the intercommunication between hardware sensor devices and software services. The embodiment may interface with the hardware devices by way of network interface cards (NICs) or other similar hardware. These hardware sensor devices include any or a combination of ecological sensors (temperature, pressure, humidity, etc.), visual sensors (surveillance cameras), depth sensors, thermal imagers, localization metadata (geospatial timeseries), receivers of wireless signals (WiFi, Bluetooth, Ultra-wideband, etc.) and acoustic sensors (vibration, audio), or any other sensor configured to collect information. The signals from these devices may be streamed across the platform as time-series data, video streams, and audio segments. The platform may interface with the software services by way of application programming interfaces (APIs), enabling these software services to consume and transform the sensor data to data understood across multiple platforms. Some software services may transform the sensor data into metadata, which may then provide to other software services as auxiliary ‘views’ or information of the sensor information. The Building Information Model (BIM) software component exemplifies this operation, taking user location information as input and providing contextualized geospatial information as output; this includes a user's proximity to objects of interest in the scene, which is crucial to the spatiotemporal analysis performed by the symbolic reasoning service (as described in more detail below). Other software services may consume data, both raw and transformed, in order to make final predictions about scene events or generate environmental control commands.

Any communication platform that provides such streaming facilities can be used in various embodiments. The system may allow manipulation of the resultant sensor data streams, predictive modeling based on those sensor data streams, visualization of actionable information, and the spatially and temporally robust classification and disambiguation of scene events. For the communication platform that underlies the system, in one embodiment, a “Security and Safety Things (SAST) platform can be used. In addition to the aforementioned utilities, the SAST platform may a mobile application ecosystem (Android), along with an API to interface these mobile apps with the sensor devices and software services. Other communication platforms can be used for the same purpose, including but not limited to, RTSP, XMPP, and MQTT.

A subset of the software services in the system may be responsible for consuming and utilizing metadata about the sensors, the raw sensor data, and state information about the overall system. After such raw sensor data is collected, preprocessing can be done to filter out noise. Additionally, these services may transform the sensor data, in order to (i) generate machine learning features that are predictive of scene events and/or to (ii) generate control commands, alarms, or notifications that will directly affect the state of the environment.

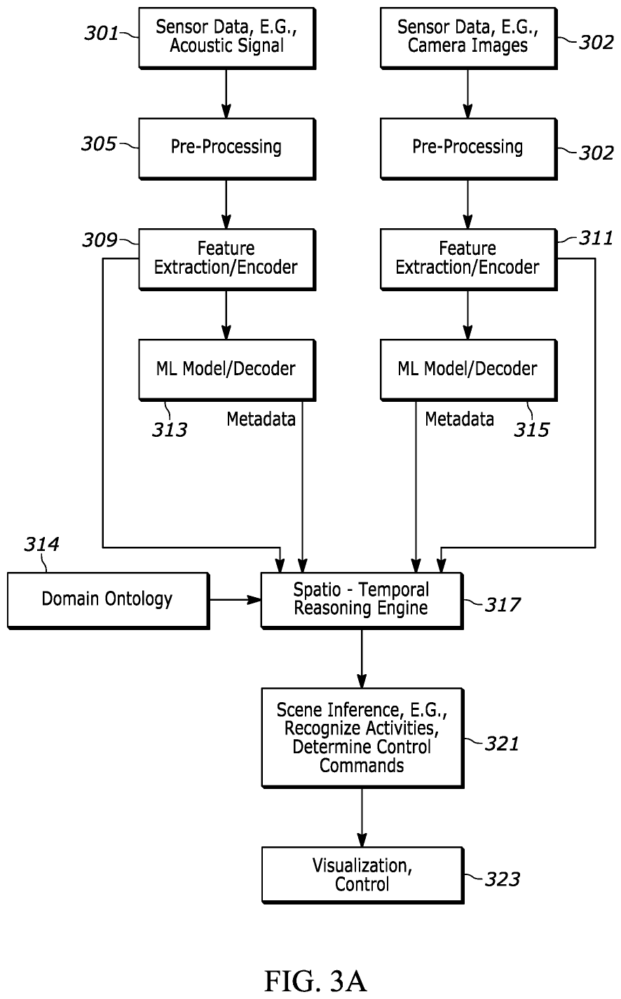

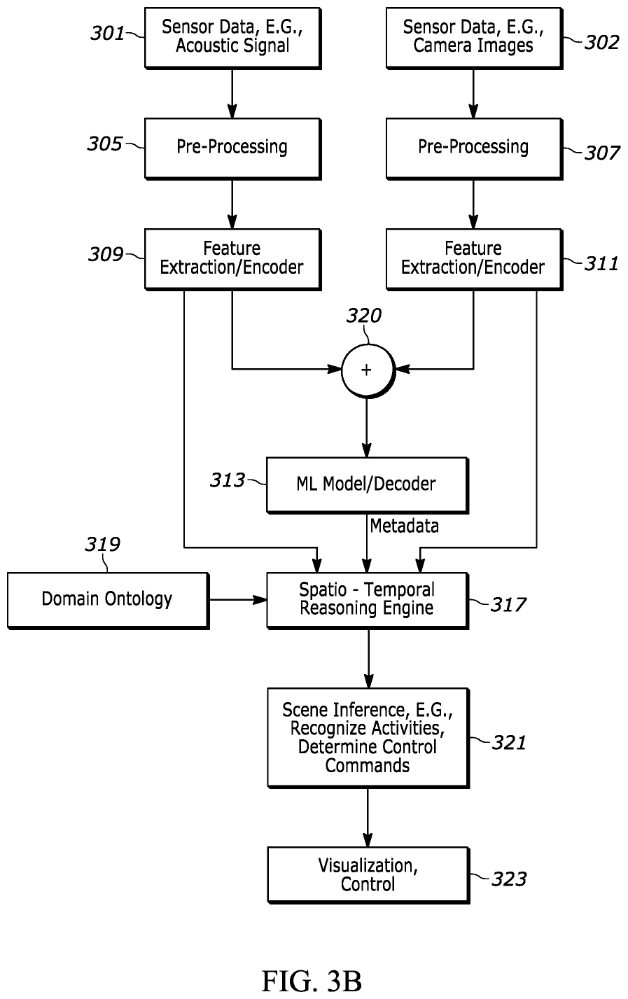

A predictive model may utilize one or more sensor modalities as input, e.g., video frames and audio segments. An initial component of the predictive model (e.g., “encoder”), may perform unimodal signal transformations on each modality input, producing as many intermediate features as there were input modalities to start with. These features are state matrices—composed of numerical values—each representing a functional mapping from an observation to a feature representation. In aggregate, all feature representations of the inputs can be characterized as a statistical embedding space, which articulates high-level semantic concepts as statistical modes or clusters. A depiction of such a computing pipeline is shown FIG. 3A and FIG. 3B.

The embedding spaces of unimodal mappings can be statistically coordinated (i.e., subjected to a condition), in order to align the two modalities or to impose constraints from one modality on another.

Alternatively, feature matrices from the modalities can be added together, concatenated, or used to find the outer product between them (or equivalents); the results of these operations are then subjected to a further functional mapping—this time, to a joint embedding space. FIG. 3B shows the computing pipeline of such an approach. Using the final component of the predictive model (i.e., “decoder”), samples from these embedding spaces (coordinated features, joint features, etc.) are then paired with labels and used for downstream statistical training and inference, such as event-classification or control.

Examples of an embodiment's sensing, prediction, and control technology may be utilized, such as occupancy estimation with depth based sensors, object detection using depth sensors, indoor occupant thermal comfort using body shape information, HVAC control based on occupancy traces, coordination of thermostatically controlled loads based on local energy usage and grid, and time-series monitoring/prediction of the future indoor thermal environmental conditions. All of these technologies can be integrated into a neuro-symbolic scene understanding system, in order to enable the scene characterization or to effect a change in the environment based on the classified events. Many such statistical models exist as software services within the System, where the inputs, the outputs, and the nature of the intermediate transformations are determined by the target event types for prediction.

In order to enable temporally robust scene understanding in the system described, the system may include a semantic model that includes (1) a domain ontology of indoor scenes (“DoORS”), and (2) an extensible set of inference rules for predicting human activities. A server, such as an Apache Jena Fuseki server, may be utilized and running in the back end to maintain (1) and (2): receive sensor-based data from the various sensors (e.g., SAST Android cameras), including Building Information Model (BIM) information, suitably instantiating the DoORS knowledge graph, and sending the results of predefined SPARQL queries to the front-end, where predicted activities are overlaid on the live video feed.

First, the system may construct a dataset of actions performed in a scene context of interest. The system may analyze certain activities that are agnostic to a wide variety of scene contexts, such as airports, malls, retail spaces, and dining environments. Activities of interest may include “eating”, “working on a laptop”, “picking up an object from a shelf”, “checking out an item in a shop”, etc.

A central notion in one embodiment may be that of event-scene, defined as a sub-type of scene, focused on events that occur within the same spatiotemporal window. For instance, “taking a soda can from the fridge” can be modeled as a scene which includes human-centered events like (1) “facing the fridge”, (2) “opening the fridge's door”, (3) “extending one's arm” and (4) “grasping a soda can”. Clearly, these events are temporally connected: (2), (3), and (4) happen sequentially, whereas (1) lasts for the whole duration of the previous sequence (facing the fridge is the condition to interact with the items placed in it). In this manner, the system may be able to jointly model a scene as a meaningful sequence (or composition) of individual atomic events.

In addition to representing event-scenes, what is crucial for enabling human activity prediction is to include observations based on sensor data in the ontology. In particular, a key type of observation for the use-case is grounded on the notion of distance; given a set of furniture pieces in a scene, whose respective locations are known a priori from the corresponding BIM model, and real-time locations of persons in a scene, DoORS can be used to infer the human activity on the basis of proximity. For instance, a person standing close to a coffee machine, with an extended arm, is (likely) making coffee, and definitely not washing dishes in the sink far away.

An observation of distance typically involves at least two physical entities (defined in the Scene Ontology by the class feature of interest) and a measure. Because OWL/RDF is not sufficiently expressive to define n-ary relations, in DoORS the system may reify the “distance” relation. For instance, the system may create the class “Person_CoffeeMachine_Distance”, whose instances have as participants a person and coffee machine (both provided with a unique ID), and whose measure is associated with a precise numeric value, denoting meters. Reification is a widely-used approach to achieve a trade-off between the complexity of a domain and the relative expressivity of ontology languages. In DoORS, assessing who is the closest person to the coffee machine at a given time, or whether a person is closer to a coffee machine than to other known elements of the indoor space, translates into identifying the observation of distance with minimum value between a given person and furniture element or defined object. Note that the shortest distance between a person and an environmental element is “0”, which means that the (transformed) 2D coordinates of an object fall within the coordinates of the considered person's bounding box.

As illustrated above, a distance is observed between a person and an environmental element (like a furniture piece or an object), is measured in meters, and occurs at a particular time. When multiple persons and environmental elements are present in a scene, distances are always represented as pairwise observations. Naturally, temporal properties of observations are key for reasoning over activities: observations are parts of events, and a scene typically includes a sequence of events. In this context, a scene like “Person x taking a coffee break”, may include a “making a coffee”, “drinking the coffee”, “washing the cup in the sink” and/or “putting the cup in the dishwasher”, where each of these events would depend on the varying proximity of person x with respect to a “coffee machine”, “table”, “sink”, and “dishwasher”. Distances are centered on the relative position of persons, and typically change at each time instant; in DoORS, events/activities are predicted from a sequence of observed distances, as in the examples above, or from the duration of an observed distance.

Results show that with utilizing two sensing modalities (video and spatial environment knowledge), the system can build software services that provide scene understanding facilities beyond a basic person detection from video analytics. Thus, more sensors utilized creates additional scene understanding. By working directly on a system with such a setup, for example on the SAST camera platform, the system can enable rapid prototyping and quick transfer of results to various use-cases. While one embodiment is on a smart building use-case, the approach remains applicable to many other areas. FIGS. 3A and 3B show two possible computation pipelines of the proposed approach.

FIG. 3A is a first embodiment of a computing pipeline configured to understand a multimodal scene. FIG. 3B is an alternative embodiment of a computing pipeline that utilizes fusing of sensor data. As shown in FIG. 3A, a system may include a computing pipeline for multimodal scene understanding. The system may receive information from multiple sensors. In the embodiment shown below, there are two sensors utilized, however, multiple sensors may be utilized. In one embodiment, the sensor 301 may acquire an acoustic signal, while the sensor 302 may acquire image data. Image data may include still images or video images. The sensors may be any sensor, such as a Lidar sensor, radar sensor, camera, video camera, sonar, microphone, or any of the sensor or hardware describe above, etc.

At block 305 and block 307, the system may involve pre-processing of the data. The pre-processing of the data may include conversions of the data into a uniform structure or class. The pre-processing may be down via on-board processing or an off-board processor. The pre-processing of the data may help facilitate the processing, machine learning, or fusion process as related to the system by updating certain data, data structures, or other data attributed to be primed for processing.

At block 309 and 311, the system may utilize an encoder to encode the data and apply feature extraction. The encoded data or feature extracts may be sent to a spatiotemporal reasoning engine at block 317. The encoder may be a network (FC, CNN, RNN, etc) that takes the input (e.g. various sensor data or pre-processed sensor data), and output a feature map/vector/tensor. These feature vectors may hold the information, the features, that represents the input. Each character of the input may be fed into the ML model/encoder as the input by converting the character into a one-hot vector representation. At the last time step of the encoder, the final hidden representation of all the previous inputs will be passed as the input to a decoder.

At block 313 and 315, the system may utilize a machine learning model or decoder to decode the data. The decoder may be utilized to output metadata to a temporal reasoning engine 317. The decoder may be a network (usually the same network structure as encoder but in opposite orientation) that takes the feature vector from the encoder, and gives the best closest match to the actual input or intended output. The decoder model may be able to decode a state representation vector and gives the probability distribution of each character. A softmax function may be used to generate the probability distribution vector for each character. Which in turn helps to generate a complete transliterated word. The metadata may be utilized to facilitate in scene understanding in a multimodal scenario by indicating information that is captured from several sensors, that together, may facilitate in indicating a scene.

The spatiotemporal reasoning engine 317 may be configured to capture relationships of multimodal sensors to help determine various scenes and scenarios. Thus, the temporal reasoning engine 317 may utilize the metadata to capture such relationships. The temporal reasoning engine 317 may then feed the model with the current event and performs prediction and outputs set of predicted events and likelihood probabilities. Thus, the temporal reasoning engine may enable to interpret large sets of data (e.g., time-stamped raw data) into meaningful concepts at different levels of abstraction. This may include abstraction of individual time points to longitudinal time intervals, computation of trends and gradients from series of consequent measurements, and detection of different types of patterns, which may be otherwise hidden in the raw data. The temporal reasoning engine may work with the domain ontology 319 (optional). The domain ontology 319 may be an ontology that encompasses a representation, formal naming and definition of the categories, properties and relations between the concepts, data and entities that substantiate one, many, or all domains of discourse. Thus, an ontology is a way of showing the properties of a subject area and how they are related, by defining a set of concepts and categories that represent the subject.

Next, the temporal reasoning engine 317 may output a scene inference at block 321. The scene inference may recognize activities, determine control commands, or categorize various events that are picked up by the sensors. One example of a scene may be “taking a soda can from the fridge” that can be outlined by several human-centered events collected by various sensors. For instance, the previous example “taking a soda can from the fridge” can be modeled as a scene which includes human-centered events like (1) “facing the fridge”, (2) “opening the fridge's door”, (3) “extending one's arm” and (4) “grasping a soda can”. Clearly, these events are temporally connected: (2), (3), and (4) happen sequentially, whereas (1) lasts for the whole duration of the previous sequence (facing the fridge is the condition to interact with the items placed in it). In this manner, the system may be able to jointly model a scene as a meaningful sequence (or composition) of individual atomic events. Thus, the system may analyze and parse different events in view of a threshold time period, compare and contrast to other events that are identify, and determine a scene or sequence in view of the event. Thus, when something lasts a whole duration, the system requirement may be that the cameras and sensors utilize the sensor data to identify the first event (“facing the fridge”), that must take place for a whole time period as compared to the other events, events 2-4. Furthermore, the system may analyze the sequence of events to identify a certain scene.

At block 323, the system may output visualization and control. For example, if the system identifies a specific type of scene, it may generate environmental control commands. Such commands could include providing alerts or begin recording data based on the type of scene identified. In another embodiment, an alarm may be output, recording may begin, etc.

FIG. 3B is an alternative embodiment of a computing pipeline. The alternative embodiment may include, for example, a process to allow a fusion module 320 to obtain the features from the feature extraction or decoder. The fusion module may then fuse all the data to generate a data set to be fed a single machine learning model/decoder.

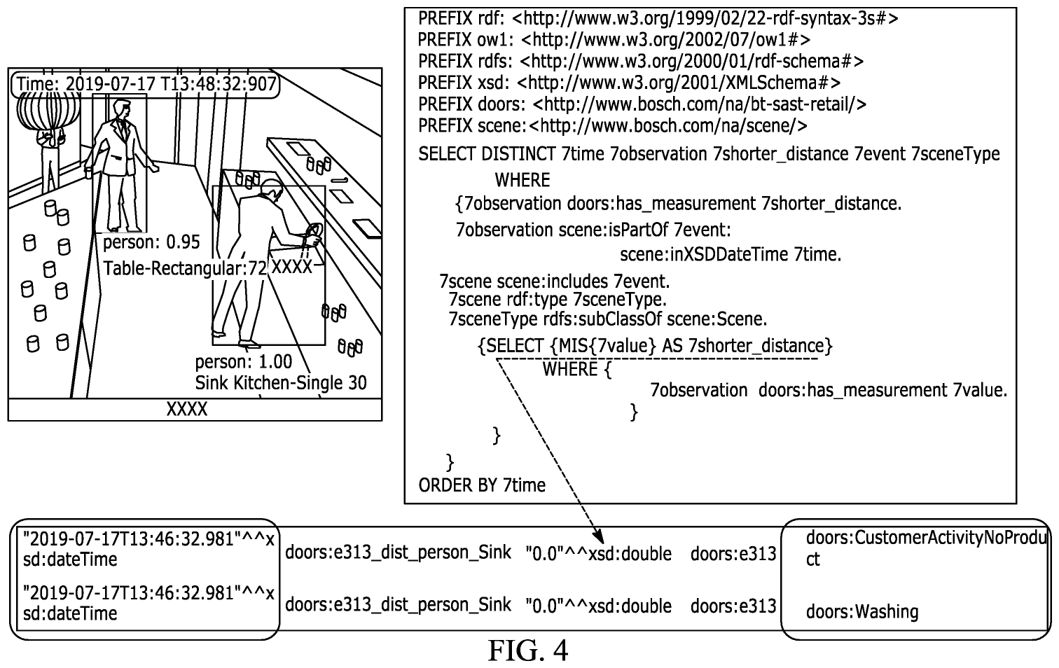

FIG. 4 is an example of a scene understanding including multiple persons. In FIG. 4, the scenario may include multiple persons (e.g., in the instance of the DoORS class “customer”), one walking by a table, and another one washing his hands in the sink. The system may correctly identify that the person who bounding box includes the bounding box of the sink (distance=“0.0”) is “washing (instance of the DoORS class “Activity”), and it can also infer that because no object (instance of the DoORS class “Product”) is detected, this type of washing activity is subsumed by DoORS class “CustomerActivityNoPRoduct” (e.g., at the bottom). The reasoning process is initiated by a query that compares distance-based measures between persons and objects in the scene, and triggers rule-based inferences to predict the most probable activities (e.g., at the top right). Note that this example was generated from a demo of the system that in the context, showed that the system could classify the person by the table was “walking” as irrelevant, and that as such activity can be recognized in the scene without the support of knowledge based reasoning, but by utilizing machine learning.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system for image processing, comprising:
a first sensor configured to capture at least one or more images;
a second sensor configured to capture sound information;
a processor in communication with the first sensor and second sensor, wherein the processor is programmed to:
receive the one or more images and sound information;
extract one or more data features associated with the images and sound information utilizing an encoder;
output metadata via a decoder to a spatiotemporal reasoning engine, wherein the metadata is derived utilizing the decoder and the one or more data features;
determine one or more scenes utilizing the spatiotemporal reasoning engine and the metadata; and
output a control command in response to the one or more scenes.

2. The system of claim 1, wherein the temporal reasoning engine is in communication with a domain ontology database and utilizes the domain ontology database to determine the one or more scenes.

3. The system of claim 2, wherein the domain ontology database includes information indicative of the one or more scenes utilizing the metadata.

4. The system of claim 2, wherein the domain ontology database is stored at a remote server in communication with the processor.

5. The system of claim 1, wherein the system includes a third sensor configured to capture temperature information, and the processor is in communication with the third sensor and receives the temperature information and extracts one or more data features associated from the temperature information.

6. The system of claim 1, wherein the processor is further programmed to fuse the one or more data features associated with the images and sound information prior to outputting the metadata.

7. The system of claim 1, wherein the processor is further programmed to separately extract the one or more data features associated with the images and sound information to a plurality of decoders.

8. The system of claim 1, wherein the decoder is associated with a machine learning network.

9. A system for image processing, comprising:
a first sensor configured to capture a first set of information indicative of an environment;
a second sensor configured to capture a second set of information indicative of the environment;
a processor in communication with the first sensor and second sensor, wherein the processor is programmed to:
receive the first and second set of information indicative of the environment;
extract one or more data features associated with the images and sound information utilizing an encoder;
output metadata via a decoder to a spatiotemporal reasoning engine, wherein the metadata is derived utilizing the decoder and the one or more data features;
determine one or more scenes utilizing the spatiotemporal reasoning engine and the metadata; and
output a control command in response to the one or more scenes.

10. The system of claim 9, wherein the first set of information and second set of information are of different types of data.

11. The system of claim 9, wherein the first sensor includes a temperature sensor, pressure sensor, vibration sensor, humidity sensor, or carbon dioxide sensor.

12. The system of claim 9, wherein the processor is further programmed to pre-process the first and second set of information indicative of the environment prior to extracting the one or more data features utilizing the encoder.

13. The system of claim 9, wherein the system includes a fusion module utilized to fuse a fusion data set from the first set of information and the second set of information.

14. The system of claim 13, wherein the metadata is extracted from the fusion data set.

15. A system for image processing, comprising:
a first sensor configured to capture a first set of information indicative of an environment;
a second sensor configured to capture a second set of information indicative of the environment;
a processor in communication with the first sensor and second sensor, wherein the processor is programmed to:
receive the first set and second set of information indicative of the environment;
extract one or more data features associated with the first set and second set of information indicative of the environment;
output metadata indicating one or more data features;
determine one or more scenes utilizing the metadata; and
output a control command in response to the one or more scenes.

16. The system of claim 15, wherein the system includes a decoder is configured to utilize a machine learning network.

17. The system of claim 15, wherein the first set of information and second set of information are of different types of data.

18. The system of claim 15, wherein the first sensor includes a temperature sensor, pressure sensor, vibration sensor, humidity sensor, or carbon dioxide sensor.

19. The system of claim 15, wherein the system includes a fusion module utilized to fuse a fusion data set from the first set of information and the second set of information.

20. The system of claim 19, wherein the fusion data set is sent to a machine learning model to output metadata associated with the fusion data set.
